(19) United States
(12) Patent Application Publication
(10) Pub. No.: US 2018/0285921 A1
(43) Pub. Date: Oct. 4, 2018

(54) MAPPING WEB IMPRESSIONS TO A UNIQUE AUDIENCE

(71) Applicant: ROY MORGAN RESEARCH LTD, Melbourne (AU)

(72) Inventors: Michele Levine, Melbourne (AU); Howard Paul Seccombe, Hampton East (AU)

(21) Appl. No.: 15/764,913

(22) PCT Filed: Sep. 29, 2016
(86) PCT No.: PCT/AU2016/050920

§ 371 Date: Mar. 30, 2018

(30) Foreign Application Priority Data
Oct. 1, 2015 (AU) 2015904013

(51) Int. Cl. G06Q 30/02; H04L 29/08

(52) U.S. Cl. CPC G06Q 30/0242; H04L 67/22; G06Q 30/0277; G06Q 30/0201; G06Q 30/0269

(57) ABSTRACT

An electronic method maps web impressions to an estimate of a unique audience. The method includes monitoring web impressions made with respect to one or more websites to identify user devices used to make the web impressions, comparing identified user devices to a database in which user devices are linked to household data to produce a first subset of web impressions to which household data is matched, and a second subset of web impressions having no matched household data, processing the first subset of impressions using an audience model of visits per household (VHH) to websites to obtain a partial estimate of the unique audience, and adjusting the partial estimate of the unique audience to take into account the second subset of impressions in order to derive a final estimate of the unique audience.

### FIELD

The present invention relates to a method and system for mapping web impressions to a unique audience.

### BACKGROUND

Currently, the chief metric for internet traffic is a count of ‘impressions’, that is, appearances on a user's screen of a web-page, advertisement, or some other content-related unit. This measure is the equivalent of ‘impacts’ or rating points for TV and ‘opportunities-to-see’ in print media.

Because of the nature of the internet and internet advertising, it is possible to measure reasonably reliably the total number of impressions delivered by, say, a campaign (e.g. a number of related advertisements on a plurality of websites during a time period) by using a technology and/or resource that covers a high proportion of all internet traffic. However, a deficiency in this approach is that the number of impressions is not necessarily indicative of the “unique audience” or “reach” for the web-page, advertisement, or other content-related unit. Reach or unique audience is the number of persons seeing the content at least once. Another important measure that cannot be derived from impressions alone is “frequency” which is the mean number of impressions seen per person reached.

Increasingly, there has been a demand for a move from measuring impressions to alternative measurement techniques which enable the total impressions figure to be broken down, as has been customary for print media, into the two components of reach/unique audience and frequency.

One attempt to determine a unique audience that has been used has been measurement in detail via a specially recruited dedicated panel of consumers. Panel members provide background information about themselves (explicitly, on joining the panel) and allow detail of their internet activity to be collected automatically.

Such a sample, with membership measured typically in thousands, has the limitation that it covers only a very small fraction of the total internet traffic. Therefore, particularly for small-volume campaigns or smaller websites, the numbers of panel members contributing information and the total quantity of information yielded can be so small as to have unacceptably high margins of error for individual estimates. Also the cost of recruiting and maintaining a panel large enough to measure even large campaigns is high and affordable only by major players.

In the present internet advertising marketplace, there is a need for an alternative technology for measuring unique audience. It would be desirable if such a technique was capable of measuring individual advertisements and very small campaigns.

### SUMMARY

In a first aspect, the invention provides an electronic method of mapping web impressions to an estimate of a unique audience, the method comprising:
monitoring web impressions made with respect to one or more websites to identify user devices used to make the web impressions;
comparing identified user devices to a database in which user devices are linked to household data to produce a first subset of web impressions to which household data is matched, and a second subset of web impressions having no matched household data;
processing the first subset of impressions using an audience model of visits per household (VHH) to websites to obtain a partial estimate of the unique audience; and
adjusting the partial estimate of the unique audience to take into account the second subset of impressions in order to derive a final estimate of the unique audience.

In an embodiment, the method comprises outputting and/or storing the final estimate of the unique audience.

In an embodiment, adjusting the first estimate includes matching the second subset of impressions to households associated with the first subset of impressions to derive values of visits per household for the second subset of impressions.

In an embodiment, each impression is generated by reporting code embedded within one or more items of content hosted on the one or more websites in response to an activity related to the respective item of content.

In a second aspect, the invention provides an audience mapping system for mapping web impressions to an estimate of a unique audience, the system having electronic components configured to:
monitor web impressions made with respect to one or more websites to identify user devices used to make the web impressions;
compare identified user devices to a database in which user devices are linked to households to produce a first subset of web impressions to which households are matched, and a second subset of web impressions having no matched household;
process the first subset of impressions using an audience model of visits per household (VHH) to websites to obtain a partial estimate of the unique audience; and
adjust the partial estimate of the unique audience to take into account the second subset of impressions in order to derive a final estimate of the unique audience.

In a third aspect, the invention provides computer program code which when executed implements the above method.

In a fourth aspect, the invention provides a tangible computer readable medium comprising the above program code.

### BRIEF DESCRIPTION OF DRAWINGS

An exemplary embodiment of the invention will now be described with reference to the accompanying drawings in which:

FIG. 1 is a block diagram of an audience mapping system of an embodiment of the invention;

FIG. 2 illustrates a Java script for gathering data in accordance with an embodiment of the invention;

FIG. 3 is a screenshot of a dashboard of an embodiment of the invention; and

FIG. 4 is a more detailed description of the contents of the dashboard.

### DETAILED DESCRIPTION

Referring to the drawings, there is shown an audience mapping system 100 that maps web impressions to a unique audience. That is, embodiments of the invention provide a system that estimates the number of unique visitors generating the total number of website impressions.

Website impressions are obtained using the applicant's ‘pixel’ data as explained in further detail below. The basic goal of the mapping technique is to estimate the number of households with at least one visitor from the ‘pixel’ data and to estimate the average number of visitors per household for each website from a model of visitors derived using an external survey. These two pieces of information are then combined by the system to get the unique audience for each website, advertisement, or some other content-related unit.

Certain embodiments enable the estimation of the unique audience for any campaign (i.e. any combination of websites) and any time period.

Particularly advantageous embodiments are:
Privacy compliant: the platform utilises best practice privacy compliance using anonymised and aggregated online behaviour.
Cookieless: making it future proof, accurate, easy to implement and privacy compliant.
Cross-Device: individually measuring all devices including mobile, tablet, desktop & laptops, removing duplicated audience.
Multi-Format: measuring display advertising, video, rich media, mobile applications, web pages.
Multi-Location: measuring online behaviour at home, work and out & about.
Scalable: designed to handle the significant increases forecasted in digital advertising.
Accurate: calibrated against the largest device insights panel, ensuring accurate coverage of ALL websites, regardless of size.
Enterprise Ready: leveraging world class data processing technology to deliver insights faster than ever before, enabling near real-time campaign insights & optimisation.
Driven by deep consumer insights: unparalleled ability to segment and profile audiences by a large range of behavioural, psychographic and product intention data.

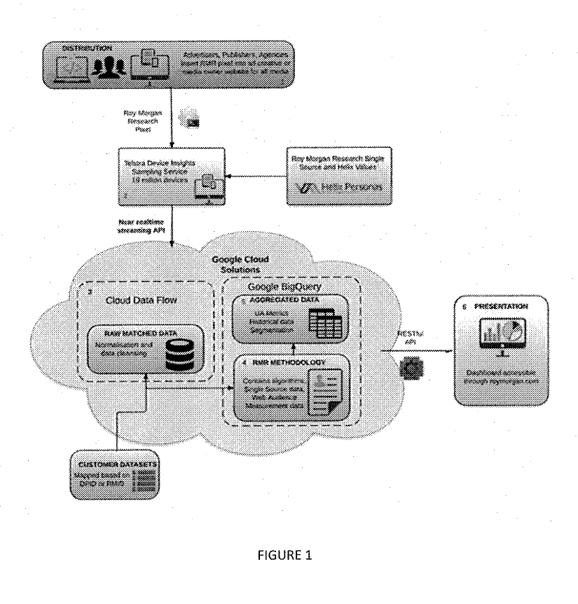

Referring to FIG. 1, there is shown a schematic diagram of a system 100 for implementing an embodiment. The applicant's Roy Morgan Research ‘Pixel’™ is distributed 110 by being implemented in content such as websites, mobile applications, and/or and in advertising campaigns (display, audio and/or video) for which it is desired to obtain audience data. The ‘pixel’ is a reporting code (a java script) embedded within the content to be monitored and collects information about activities in relation to the content, for example, a user opening the page, a user having the advertising campaign served or a user clicking on the creative content. Each of these activities is collected by the reporting code as a web impression. Clicks are treated as a special case of web impressions indicating a higher level of interactivity. In one example, the information the ‘pixel’ code collects is a time stamp, browser, operating system, local time and referring URL. It also works across all available devices, i.e. desktop, mobile and tablet. The pixel does not drop a cookie, meaning it is not affected by cookie deletion or 3rd party cookie blocking. Instead, the ‘pixel’ fires with each ad impression, click or page load depending on how it was delivered within the content.

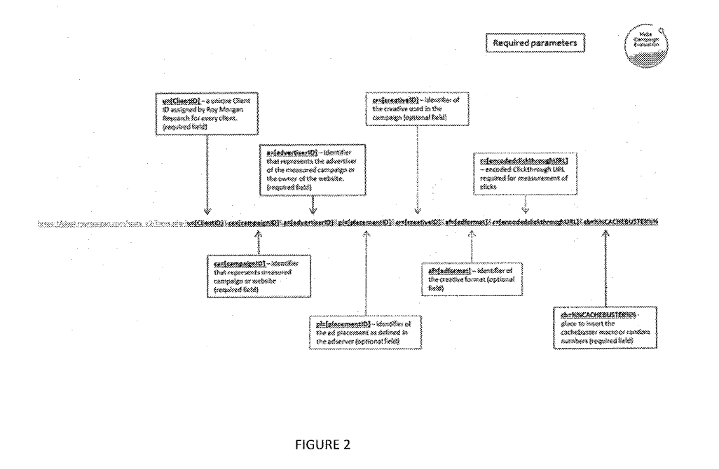

The ‘pixel’ is a line of java script which is embedded in content and will fire when loaded. An example, of a java script for the ‘pixel’ is shown in FIG. 2 from which it will be appreciated that the java script includes the elements:
u=[ClientID] 210—a unique Client ID assigned by the system operator for every client. This is a required field.
ca=[campaignID] 220—an identifier that represents measured campaign or website. This is a required field.
a=[advertiserID] 230—an identifier that represents the advertiser of the measured campaign or the owner of the website. This is a required field.
pl=[placementID] 240—an identifier of the advertisement placement as defined in the ad server. This is an optional field.
cr=[creativeID] 250—an identifier of the creative content used in the campaign. This is an optional field.
af=[adformat] 260—an identifier of the creative content format. This is an optional field.
r=[encodedclickthroughURL] 270—an encoded Clickthrough URL required for measurement of clicks.
cb=% % CACHBUSTER %% 280—a place to insert the cachbuster macro or random numbers. This is a required field.

Each event/impression is recorded locally at the web server (not shown) hosting the content and streamed 115 to Sampling Service 120. In one example, the sampling service 120 uses data from a database having records linking user devices to details of user addresses so that events corresponding to devices in the database can be tied to a particular household, for example, a database of a telecommunications provider. That is, the Sampling Service extracts the device ID recorded by the pixel code and attempts to match it to devices stored in the database 130. In one example, the households are identified within the database by delivery point identifiers (DPID) that uniquely identify households. In another embodiment, the events could be linked to specific addresses and those addresses used to identify households. It will be appreciated that at this stage, even though some impressions are linked to a household it is not possible to determine how many individuals within that household are responsible for the impressions. The unique audience model 154 described below enables this to be determined.

When technically possible the events streamed to the sampling service by the pixel data, get additional data appended from the applicant's database 130 of data characteristic of specific users in the form of the applicant's “Helix Personas Segment” or “Single Source” information. Then the data of each event is passed to Google Data Flow 145 running in cloud based environment 140. In Google Data Flow 145 the data is normalised, mapped and cleansing rules are applied as described in further detail below. The raw matched data 146 that results contains information about the event such as data passed from the user browser (Browser, Operation System, Device Type), campaign information (creative name, advertisement format used, placement (where the advertisement has been displayed), website where the campaign has been displayed, and/or website information website where the pixel fired) as well as data matched from database 130 (including Helix Personas. There is also a possibility to append data from other customised datasets 160 to the events provided that the matching key is compatible.

After the data is ready for further processing the tables of raw matched data database 146 of Google Cloud Data Flow 145 are pushed to Big Query 150. Cloud Data Flow is a programming model for batch and streaming big data process available from Google Inc. <<https://cloud.google.com/dataflow/>>. Big Query is an analytics service available from Google Inc. <<https://cloud.google.com/bigquery/>>.

The unique audience model 154 described in further detail below and implemented in Google Big Query 150, processes the raw matched data twice daily at 3 AM and 3 PM. The unique audience model 154 implements statistical calculations that are applied to convert impressions to Unique Visitors numbers. Then the data is aggregated and results are saved in an aggregated database 152 in a number of tables including: Daily Unique Audience for Campaigns, Cumulated Unique Audience for Campaigns, Daily Unique Audience for Websites within Campaigns, Cumulated Unique Audience for Websites within Campaigns and a table with aggregated events. In one example, the aggregated database contains following data points: Unique Audience count, Campaign information, Website information, Data sent from the browser, Area, Helix Persona and Helix Community.

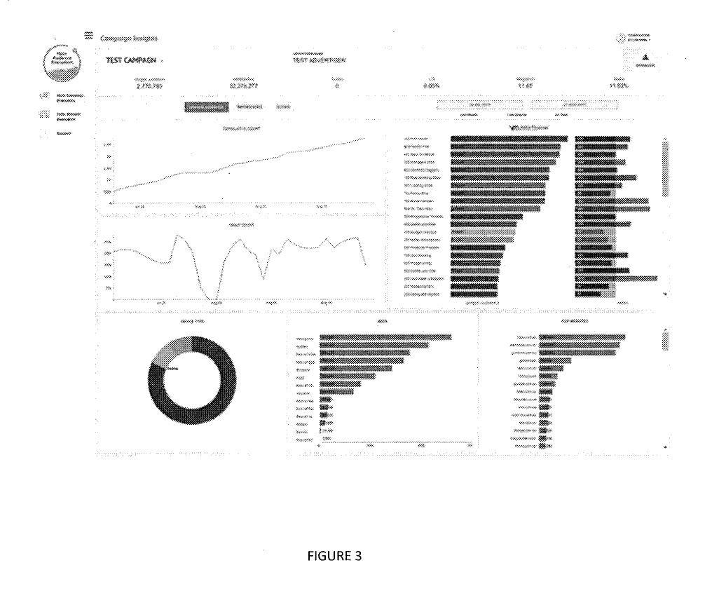

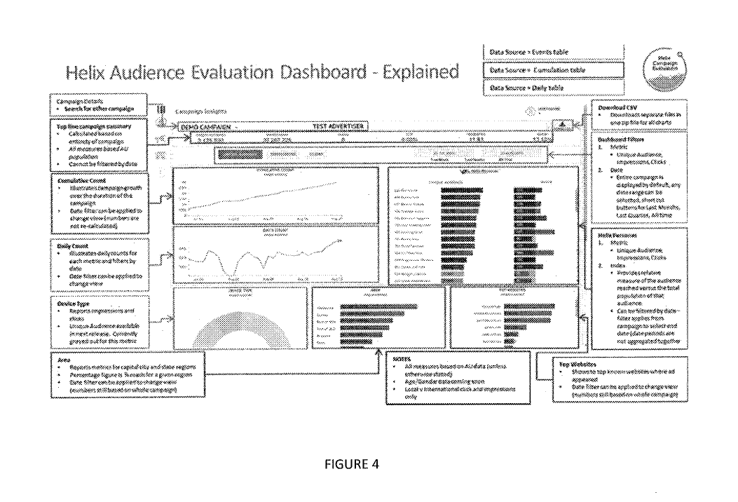

The aggregated tables 152 are stored in Big Query 152 and are connected directly to an Audience Evaluation interface 170, where clients can analyse the data based on the charts presented in the dashboard shown in FIGS. 3 and 4. Big Query 150 also has API connectors with various Business Intelligence Tools like Tableau or Yellow Fin, where the clients can create their customised charts. That is, the metrics are pushed into a reporting environment where the subscriber will be able to view the results that can be accessed via a dashboard. Depending on the embodiment, different levels of profiling data may be available. In one example, the profiling will contain top line metrics and Helix Personas. Another example, will include additional profiling data (e.g. age, gender, device).

FIG. 3 shows an example dashboard of an embodiment of the invention. The dashboard 300 is divided into a number of areas and includes:
a cumulative count of the unique audience in area 310;
a daily count of the unique audience in area 320;
a breakdown by device type in area 330;
a breakdown by Helix Personas in area 340;
a breakdown by geographical area in area 350; and
a list of top websites in area 360.

FIG. 4 contains a more detailed explanation 400 of the dashboard 300. The explanation 400 shows that campaign details area 410 allows a user to search for other campaigns. Campaign summary top line area 420 displays key metrics calculated based on the entirety of the campaign. In this example, all measures are based on the Australian population.

Cumulative count area 310 illustrates campaign growth over the duration of the campaign. A date filter can be applied to change the view, however numbers are not recalculated.

Daily count area 320 illustrates daily counts for each metric and filters by date. The date filter can be applied to change the view.

Device type area 330 reports impressions, clicks or unique audience by device type.

The geographical area 350 reports metrics for capital city and state regions. The percentage figure given is percentage reach for a given region. A date filter can be applied to change the view. Download CSV button 430 allows a user to download separate files in one zip file for all charts. Dashboard filters 440 allow the user to filter by different metrics such as unique audience, impressions and clicks. The dashboard filters 440 also allow the user to filter by date. The default is to display the entire campaign but any date range can be selected. Shortcut buttons are provided for the last month's data, the last quarter's data and all data.

Helix personas area displays a metric either for unique audience, impressions or clicks. It also displays an index which provides a relative measure of the audience reached versus the total population of that audience. This area can be filtered by date. The filter applies from campaign to select end dates. Date periods are not aggregated together. Top websites area 360 shows top known websites where content appeared. Again, a date filter can be applied to change the view.

### Roy Morgan Single Source Data

Embodiments of the invention employ data from the Roy Morgan Single Source™ database which provides a core set of data relationships derived from the applicant's proprietary database. These include:
Detailed internet behaviour such as website visitation, use of mobile apps and categories of websites visited.
Devices owned (eg mobile phones, tablets, desktops etc.
Operating system.
Network used (eg Telstra, Optus, Vodafone)
Detailed demographics.
Time (eg January).
Location (ie geography such as a street address, statistical area level 1 (SA1)—the smallest unit for the release)
Helix Personas™—a geo-digital psychographic segmentation. Combining location, demographics, lifestyle, attitudes, behaviours and values.

The Roy Morgan Single Source database is able to cross tabulate the thousands of possible relationships between these critical underlying variables so it is possible produce a target matrix of what the end result is to look like (eg how many females 18-24 in a census level geographical area, who are on the network of a specific telecommunication provide, using an iPhone who visit the “Cleo” website). In this way the data that is collected by the “Pixel” is processed by the model informed by the deep relationship inherent in this dataset.

### Unique Audience Model Summary

The unique audience model 154 produces estimates of impressions, clicks and unique audience for any time period and any combination of websites, on the total level as well as within a particular geographical area or Helix Community™. The model 154 does not use weights to project estimates to the population. Helix Communities are groups of Helix Persona that have some common characteristics. It computes the unique audience/impressions/clicks separately among records with delivery point identifiers (DPID) and among records without DPID and then adds them to get total estimates. DPIDs uniquely identify households so that web impressions can be tied to a specific household.

Certain impressions may be considered ‘out of scope’ for present purposes, such as impressions registered by individuals located outside Australia, and it is necessary to be able to identify and discount these, or at least to be able to make a realistic estimate of the numbers involved and may be excluded by data filtering. For example, in some embodiments all business-related account holders are excluded from audience calculations.

### 1.1 DPID Estimates

Among DPID records, unique audience calculations are performed within each household separately using VHH values. VHH values (visitors per household) are modelled by seven Helix Communities by metro/country for each website separately. For websites which are not identified the default VHH value is 2.245.

For each household, to obtain the number of visitors is generally computed as the maximum VHH value but that maximum value is reduced if the number of household records is small. The reason for the reduction is to take into account the fact that the number of unique visitors for a small number of records is likely to be less than the average number of unique visitors for a large number of records. The reduction formula is described below.

The combined numbers of household visitors are then added across all campaign households to get the unique audience. Impressions and clicks are counts of appropriate DPID records filtered by time period, websites or area/Community.

### 1.2 Non-DPID Estimates

Non-DPID records don't have, by definition, a household identification (i.e. can't be matched to database 130 by sampling service 120) and so cannot have area/Community values either. A significant part of the model 154 is to match non-DPID records with DPID records and then combine matched non-DPID records on the household level.

The matching is done for each website/day pair separately by computing the ratio of DPID impressions to non-DPID impressions. For example, if a particular website has 30,000 non-DPID impressions and 10,000 DPID impressions for a particular day then the ratio for this website/day pair will be 30,000/10,000=3. These ratios are called matching factors and the model 154 applies the factors for each household separately.

The matching factors are applied differently for impressions/clicks and unique audience.

### Non-DPID Impressions and Clicks

For impressions and clicks, matching factors are used as mathematical factors to convert DPID counts into non-DPID counts. For example, if a household has 5 DPID impressions and the matching factor for a website/day pair is 3 then that household will have 5*3=15 non-DPID impressions ‘attached’ to it. Similarly, if the household has 2 DPID clicks and the matching factor is 3 then there will be 2*3=6 non-DPID clicks ‘attached’ to the household.

For several websites and/or several days, non-DPID impressions and clicks are combined within each household separately. For each website/day pair, its DPID impression/click count is multiplied by the corresponding matching factor and these products are added across all website/day pairs visited by the household. Non-DPID impressions/clicks are then added across all household to get total non-DPID impressions clicks.

### Non-DPID Unique Audience

For the unique audience, the maximum value for matching factors is 3.0. These capped matching factors are considered as ‘fused’ VHH values on the household level. So if the capped value is, for example, 2.5 for a particular website/day then each household will have 2.5 ‘fused’ visitors for that website/day pair.

Note that fused VHH values are related to a ‘copy’ of the original set of households derived from the sampling service 120. This ‘copy’ set does not overlap with original households, but has the same household count as in the original set. In one example, a telecommunication provider database was used which included about 50% of all Australian households with internet connection so that, in this example, non-DPID records should represent the same number of households as DPID records.

For several websites and/or days, the maximum fused VHH value is taken which is then reduced, similarly to DPID VHH values, if the household number of DPID records is small. These combined fused VHH values are added across all households to get the total non-DPID unique audience. This technique assumes that the accumulated audience among non-DPID records will grow at a similar rate as the accumulated audience among DPID records.

The audience model 154 also combines all websites without a name, i.e. it assumes that all records without a website belong to a single no-name-website. This is done separately among DPID records and non-DPID records. The no-name-website will get its own matching factor computed similarly to websites with a valid name.

Note that if a website does not have DPID records on a particular day then there will be no matching between non-DPID and DPID records for that website/day so that the modelled unique audience for that website/day pair will be zero. However, these non-DPID records are not ‘lost’ in total audience calculations: they are added to non-DPID records of the no-name-website.

### 1.3 Total and Filtered Estimates

For each household, DPID and non-DPID estimates are added to get final household impressions, clicks and visitors. Final household estimates are then added across all households to get total estimates.

To get estimates within a particular area or Community, household estimates are added only across households from that area or Community.

The model 154 can be considered as a form of a data fusion where matching factors are used as ‘building blocks’ to get the unique audience, impressions and clicks for any combination of websites, days or area/Community.

The model 154 will not have the declining reach problem, i.e. when more websites or days are added to a database, the unique audience cannot become smaller than it has been in the original database. For any time period or website or area/Community filter, the unique audience estimate will never exceed the count of impressions.

### 2. Detailed Steps to Calculate the Unique Audience, Impressions and Clicks for any Campaign

There are seven steps implemented in total:

The first step identifies all unique households (DPIDs) so that visitor counts can be performed within each household separately.

Steps 2 and 3 compute matching factors for each website and day. These factors are ratios of non-DPID records to DPID records for each website/day pair.

Step 2 computes matching factors for all websites with a valid name while Step 3 computes factors for all websites without a name, i.e. where the corresponding name in the data file is blank. Given that there is no way to distinguish between blank websites, all such websites are combined into a single no-name-website, i.e. the assumption is that all blank websites have the same matching factor.

Once matching factors have been computed, all calculations are performed on the household level using only DPID records so that non-DPID records are no longer required.

Steps 4, 5 and 6 compute impressions, clicks and unique audience, respectively. All calculations are performed within each household separately. When there are several websites and/or days, the corresponding estimates for each website/day pair are combined on the household level.

For each household, there are always two estimates of impressions, clicks and visitors: one estimate is based on DPID records and another estimate is based on non-DPID records (using matching factors). These two estimates are computed separately, using different formulae, and then added to get the final household estimate of impressions, clicks and visitors.

The formula for household impressions and clicks is: DPID impressions/clicks are simply counts of the corresponding household records while non-DPID impressions/clicks are obtained by multiplying DPID counts by matching factors.

The household audience formula has two parts: the DPID part of the audience depends on VHH values while the non-DPID part depends on matching factors. Also, both parts depend on the number of household records using the assumption that a small number of records is likely to result in a lower-than-average number of unique visitors.

Step 7 then aggregates household estimates, i.e. adds household impressions, clicks and visitors across households from the corresponding area or Community filter.

Step 1. Identify unique households which visit at least one website from the campaign.

Step 2. Compute matching factors for all website/day pairs with a valid website name:

a) If the count of DPID impressions on that day is non-zero then the matching factor is computed as the ratio of non-DPID impressions to DPID impressions.
b) If the count of DPID impressions on that day is zero then the matching factor is zero.

Step 3. For each day, combine all websites without a name into a single no-name-website and compute the matching factor for this website in the following way:

a) Compute N1 as the number of DPID impressions on that day across websites without a name.

b) Compute N2 is the number of non-DPID impressions on that day across websites without a name.

c) Compute N0 as the sum of non-DPID impressions on that day across websites with a valid name but without DPID records.
d) Compute the matching factor as the ratio (N2+N0)/N1; but if N1 is zero then the matching factor is zero.

The no-name-website and its matching factor should be included into all calculations on the next steps.

Step 4. For each household, compute the total number of impressions by the formula:

I₁*(F₁+1)+ . . . +I_{w}*(F_{w}+1),

where Fᵢ is the matching factor for i-th visited website, Iᵢ is the count of DPID impressions for i-th visited website and w is the number of websites visited by the household.

Step 5. For each household, compute the total number of clicks by the formula

J₁*(F₁+1)+ . . . +J_{w}*(F_{w}+1),

where Fᵢ is the matching factor for i-th visited website, Jᵢ is the count of DPID clicks for i-th visited website and w is the number of websites visited by the household.

Step 6. For each household, compute the total number of visitors in the following way (w is the number of websites visited by that household):

a) Compute the proportion P=(min(N,8)−1)/7 where N is the number of households records.
b) Compute the DPID audience A₁=P*max(V₁, . . . , V_{w})+(1−P), where Vᵢ is the VHH value for i-th website.
c) Compute the maximum matching factor

FM=max(min(F₁,3), min(F₂,3), . . . , min(F_{w},3)), where Fᵢ is the matching factor for i-th website. In other words, matching factors of individual websites are first capped by 3 and then the maximum value of capped factors is taken.

d) Compute the non-DPID audience A₂=P*FM+(1−P)*min(FM,1)
e) Compute the total number of household visitors as A₁+A₂.

Step 7. Compute the final estimate of impressions/clicks/audience as the sum of the corresponding household impressions/clicks/visitors across households from the area or Community filter.

### Obtaining VHH Values for the Model

The initial research on VHH values was conducted using September-November 2014 data from the Roy Morgan internet panel and household audience estimates for 2,486 websites. 18 time-periods were examined. The household audience is the number of households with at least one visitor.
(1) The whole three-month period.
(2) October alone.
(3-6) Four individual weeks of October.
(7-18) Twelve individual days (three from each week of October).

For each period VHH values were calculated for the whole population and for each of the 14 Helix Community/area cells. These data were used to model 14 VHH values for each website.

### Statistics of VHH Values (for the Test Period)

Out of 2,486 websites from the Roy Morgan internet panel, 847 websites had zero recorded quarterly audiences and so were excluded from the analysis. Out of remaining 1,639 websites, some were excluded because they did not have valid total VHH values. Only VHH values between 1.0 and 3.5 were used. Values greater than 3.5 seem excessive and unreliable while values less than 1.0 are not valid because the number of people cannot be smaller than the number of households. Also, websites where all valid total VHH values were the same for all time frames (this can happen if, for example, only one person visited a website for a few days and nobody else visited the website during the month) were excluded from the analysis. Finally, websites with only one valid total VHH value were excluded as well because a single value does not require any modelling.

As a result, 298 out of 1,639 websites had to be excluded as well: 87 websites did not have valid total VHH values (i.e. all values were either less than 1.0 or greater than 3.5), 174 websites had only one valid total VHH value and for 37 websites, all their valid VHH values were the same. Hence, only 1,341 websites were used in the modelling analysis. To analyse the distribution of total VHH values, these websites were split into three groups—‘large’, ‘medium’ and ‘small’:

Group 1: 164 websites where the monthly household audience is at least 6%.
Group 2: 314 websites where the monthly household audience is between 2% and 6%.
Group 3: 863 websites where the monthly household audience is less than 2%.

Table 1 shows summary statistics for total VHH values across the three website groups as well as in total. The first row shows the number of cases (i.e. valid total VHH values across all time frames) for each group. The next two rows show the mean VHH value μ and the standard deviation σ of VHH values from each group. The next seven rows show the percentage distribution of all valid VHH values by intervals. The row with μ±1.96*σ shows the interval of 1.96 standard deviations around the mean value and the last row shows the percentage of VHH values contained in that interval.

TABLE 1

| Statistic | Total | Group 1 | Group 2 | Group 3 |
|---|---|---|---|---|
| Number of | 15,176 | 2,867 | 4,821 | 7,488 |
| cases | | | | |
| μ | 2.14 | 2.24 | 2.18 | 2.07 |
| σ | 0.55 | 0.38 | 0.53 | 0.60 |
| [1.0, 1.5) | 13.22% | 2.41% | 10.31% | 19.24% |
| [1.5, 2.0) | 27.57% | 22.53% | 28.60% | 28.83% |
| [2.0, 2.2) | 14.16% | 20.47% | 15.39% | 10.95% |
| [2.2, 2.4) | 13.79% | 25.11% | 12.42% | 10.34% |
| [2.4, 2.6) | 11.21% | 14.96% | 11.68% | 9.47% |
| [2.6, 3.0) | 12.93% | 10.43% | 13.59% | 13.47% |
| [3.0, 3.5) | 7.11% | 4.08% | 8.01% | 7.69% |
| μ ± 1.96 *σ | (1.07, 3.21) | (1.49, 3.00) | (1.13, 3.22) | (0.90, 3.24) |
| % in μ ± | 95.78% | 93.62% | 95.04% | 96.69% |
| 1.96 *σ | | | | |

Table 1 shows that for small websites, VHH values tend to be smaller. This actually makes sense because small websites tend to be more specialised and so they are likely to attract only one household member from many households. Small websites also tend to have fewer VHH values in the middle and more VHH values at the lower and high end. This is probably the reason for small websites to have a higher standard deviation. On the other hand, large websites tend to have more VHH values in the middle: 93.51% of their VHH values are between 1.5 and 3.0 and 60.54% of values are between 2.0 and 2.6.

As expected, most values are centered around 2.245 which is the ratio of all eligible people (17,632,399 Australians who accessed the internet in the last 12 months) to all eligible households (7,853,740 households with internet access).

### VHH Modelling

For each website, the first step was to combine, if necessary, some of the original 14 Community/area cells (i.e. 7 Communities by metro/country). Cells which are combined would get the same modelled VHH values. A cell was combined with another cell if it had a monthly people count of less than 5,000 or had less than 2 valid Roy Morgan internet panel VHH values. For small websites, i.e. with the monthly household audience below 2%, all cells were combined so that only total VHH values were considered.

The next step was to use several different techniques to model VHH values for combined cells.

For websites where all cells were combined, it was simply the selection of a single VHH value which gave the best fit to total people counts, i.e. with the lowest average absolute difference between actual and predicted total people counts.

For other websites, the modelling procedure was more complicated.

First, a single modelled VHH value was derived for each Community/area cell separately (across time periods with valid Roy Morgan internet panel VHH values), i.e. without fitting total audience estimates. This initial set of VHH values was then improved to get the best fit to total estimates using two different techniques:
1. Fix VHH values for all cells except one. For the cell where VHH values can change, find the VHH value which gives the best fit to total estimates. Repeat this for each cell.
2. Use the gradient method, i.e. compute the gradient at the current set of VHH values and then find the best fit to total estimates in the direction of the gradient or in the opposite direction.

These techniques produced two modelled sets of ‘competing’ VHH values.

The same techniques were also applied to another initial set of VHH values, derived for each cell separately, where metro and country cells for the same community were combined. This produced two more sets of modelled VHH values. The fifth set consisted of a single VHH value with the best fit to total audience estimates.

Finally, another technique was to minimise the sum of squared differences between actual total people counts and predicted total people counts. While this should give the best results from the mathematical point of view, the problem was that this technique often produced invalid VHH values, i.e. either less than 1.0 or greater than 3.5. In such cases, all invalid values were replaced by closest valid values and this preliminary set was again improved using the first technique above. This method produced the sixth modelled set of VHH values to consider.

Out of the six sets of VHH values, the set with the best fit to total audiences was then chosen as the final modelled set. Roughly, the best fit was produced by the sixth set for 66% of websites and by one of the first five sets for 34% of websites. In some cases, the final modelled set was also a combination of two out of the six sets, to avoid too low or too high VHH values.

To get a summary of model results, all predicted total people audiences (across all available websites and time periods) were compared with total actual people audiences and were classified by intervals depending on the audience magnitude. For each interval, the average predicted estimate and the average error was calculated. Table 2 summarises model results:

TABLE 2

| | | Average | Average | | |
|---|---|---|---|---|---|
| | | predicted | error | Number | Simple random |
| Interval | | audience(%) | (%) | of cases | sample size |
| 1 | <1% | 0.29 | 0.040 | 10,927 | 18,276 |
| 2 | [1%, 2%) | 1.41 | 0.091 | 1,735 | 16,775 |
| 3 | [2%, 3%) | 2.47 | 0.108 | 788 | 20,539 |
| 4 | [3%, 5%) | 3.86 | 0.118 | 648 | 26,693 |
| 5 | [5%, 8%) | 6.31 | 0.148 | 487 | 23,807 |
| 6 | [8%, 20%) | 12.12 | 0.240 | 430 | 18,449 |
| 7 | >20% | 34.56 | 0.473 | 161 | 10,112 |

The last column shows the size of a simple random sample that would give the same standard error as the average error for the average predicted audience. For example, in a simple random sample of 18,449 respondents, the standard error of proportion estimate 12.12% would be 0.24%. The average simple random sample size across seven intervals is about 18,677.

The table shows that results look quite reasonable given that it is a simple audience model and the same VHH values are applied to all time frames.

Research has also been conducted on alternative formulae to predict people counts from household counts. In particular, the linear regression formula α*H+b was investigated, where H is the number of households. In terms of precision, it was only a marginal improvement: the average error (i.e. the absolute difference between predicted and actual people counts) was typically reduced by 2-3%.

However, the regression formula has two issues. The first issue is that the coefficient α could be negative so that there is no guarantee that all predicted people counts will be positive when the formula is applied to other data sets. The second issue is that the second summand, even if it is positive, would depend on the actual audience values from the Roy Morgan internet panel. In other words, the constant b would be chosen because it gives the best fit to actual Roy Morgan internet panel people audience counts. However, the same constant may not produce the best fit to other people audience counts because other counts could be lower or higher than the Roy Morgan internet panel counts.

Similar issues have been discovered with other, more complicated, formulae. Therefore, in an embodiment, the system uses the simplest formula to get the people audience (i.e. multiply the household audience by the VHH value) because it is much more likely to have a similar precision when applied to other data.

Finally, a special VHH value has been modelled to deal with websites which don't have Roy Morgan internet panel data. It is very unlikely that such websites would have high audiences and so this model was based on all websites where the monthly household audience is less than 1.5%. All total quarterly, monthly, weekly and daily audiences with valid VHH values were considered for these websites and there were 1,504 such cases.

The modelled VHH value for these cases turned out to be 2.245 with the average error of 0.084%. This error, even though higher than the average error across individual small websites, is still reasonable given that the single VHH value fits 1,504 cases.

### The Formula to Reduce Combined VHH Values.

Let V be the maximum VHH value across websites visited by a particular household and let N be the number of records for that household. The reduced VHH value Vᵣ is then computed by the following formula:

Vᵣ=P*V+(1−P),

where P=(min(N,8)−1)/7, i.e. a fraction from 0 to 1. Table 3 shows the formula for Vᵣ for the number of records from 1 to 8. The third column also shows Vᵣ values when V=2.5:

TABLE 3

| N | Vᵣ formula | Vᵣ for V = 2.5 |
|---|---|---|
| 1 | 1 | 1 |
| 2 | (V + 6)/7 | 1.214 |
| 3 | (2V + 5)/7 | 1.429 |
| 4 | (3V + 4)/7 | 1.643 |
| 5 | (4V + 3)/7 | 1.857 |
| 6 | (5V + 2)/7 | 2.071 |
| 7 | (6V + 1)/7 | 2.286 |
| 8 | V | 2.5 |

When the number of records is more than 8, Vᵣ is always the same as V.

### Examples

In order to understand the application of embodiments, it is helpful to consider the needs of users. For example, in one use case, as an Advertiser or Agency for my ad campaigns:
I need to understand as much as possible about the audience that is exposed to my online advertising campaign (both current campaigns and past campaign).
I need to know how it has performed today, yesterday, the past week, past month. Are certain times of day or days of week better?
What websites is my ad appearing? Which websites perform best?
How many people see my ad . . .
who are they?
where do they see it?
on what device?
where are they located?
who clicks on it?
what else can I learn about them (i.e. people who click on my ad, are twice as likely to own a BMW or 20% less likely to have children)?
How does this compare with who I am targeting and where I am targeting them?
Which ad type and creative is performing best, and on which sites?
I want to see historical data on past campaigns?
I want to be able to compare current to past campaigns?
I want to compare my campaign performance for this week against last week (i.e. comparing a companion over two different time periods)?
I need metrics that mean the same thing on other platforms—impressions, clicks, reach, frequency, GRP?
I want to know how my campaigns compare to industry benchmarks. For example does my auto campaign perform better for CTR than the industry average? What percentage of my targeted audience am I reaching? What is this in relation to overall segment population (e.g. my target is helix 101 . . . I am reaching 80% of them online?

### Example Scenario One

A large agency client is running 30 different campaigns for various clients at any given point in time.

These campaigns are set up and monitored by multiple people within the agency (trader, account executive, buyer/planner etc.)

Each of these people will be interested in the campaigns they own/manage, so they want to be able to find it easily via their dashboard.

Each day they will review the campaign performance, and could possibly need to look at it refreshed multiple times a day (i.e. they will query the campaign data more than once a day).

Based on this information they may need to then—

Adjust the campaign on their trading platform
Share insights and/or export data.
Campaigns may last a few days or could be ‘always on’
Campaigns may deliver 10,000 to 1+million impressions a day (i.e. campaign volume will vary).

When a campaign ends, the data needs remain available.

### Example Scenario Two

A small to medium business with a small marketing/digital team running online display campaigns through the year.

They run these campaigns in house, and also leverage other digital channels, such as search, social, and Mobile.

For large campaigns, such as Xmas, or mid-year stocktake they buy premium inventory; however, most display spend is via an exchange.

They have recently become a Helix Personas customer (CRM coded up), so want to also use the Roy Morgan ad tracking pixel.

Within the business there is only one or two people that manage digital campaign, they monitor performance daily, but report to management weekly.

The reporting information is used to understand the audiences their campaign is reaching, and effectively they are engaging. Campaign targeting is continually optimised.

Digital reporting comes from a number of different systems (facebook, google, exchanges), so being able to export data easily is important, as well as simple summary charts that can be easily shared (copied, emailed).

Further aspects of the method will be apparent from the above description of the system. It will be appreciated that at least part of the method will be implemented electronically, for example, digitally by a processor executing program code. In this respect, in the above description certain steps are described as being carried out by a processor, it will be appreciated that such steps will often require a number of sub-steps to be carried out for the steps to be implemented electronically, for example due to hardware or programming limitations. For example, to carry out a step such as evaluating, determining or selecting, a processor may need to compute several values and compare those values.

As indicated above, the method may be embodied in program code. The program code could be supplied in a number of ways, for example on a tangible computer readable storage medium, such as a disc or a memory device, e.g. an EEPROM, (for example, that could replace part of memory 103) or as a data signal (for example, by transmitting it from a server). Further different parts of the program code can be executed by different devices, for example in a client server relationship. Persons skilled in the art, will appreciate that program code provides a series of instructions executable by the processor.

Herein the term “processor” is used to refer generically to any device that can process instructions and may include: a microprocessor, microcontroller, programmable logic device or other computational device, a general purpose computer (e.g. a PC) or a server. That is a processor may be provided by any suitable logic circuitry for receiving inputs, processing them in accordance with instructions stored in memory and generating outputs (for example on the display). Such processors are sometimes also referred to as central processing units (CPUs). Most processors are general purpose units, however, it is also know to provide a specific purpose processor, for example, an application specific integrated circuit (ASIC) or a field programmable gate array (FPGA).

It will be understood to persons skilled in the art of the invention that many modifications may be made without departing from the spirit and scope of the invention. In particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. An electronic method of mapping web impressions to an estimate of a unique audience, the method comprising:
monitoring web impressions made with respect to a website to identify user devices used to make the web impressions in respect of content on the website by generating the web impressions at the web server hosting the content, wherein each web impression is generated by reporting code embedded within one or more items of content hosted on the website in response to an activity related to the respective item of content;
comparing identified user devices to a database in which a plurality of user devices are linked to household data to produce a first subset of web impressions to which household data is matched, and a second subset of web impressions having no matched household data;
processing the first subset of web impressions using an audience model of visits per household (VHH) for the website to obtain a partial estimate of the unique audience for the website; and
adjusting the partial estimate of the unique audience to take into account the second subset of impressions in order to derive a final estimate of the unique audience for the website.

2. A method as claimed in claim 1, comprising outputting and/or storing the final estimate of the unique audience.

3. A method as claimed in claim 1, wherein adjusting the first estimate includes matching the second subset of impressions to households associated with the first subset of impressions to derive values of visits per household for the second subset of impressions.

4. A method as claimed in claim 1, comprising monitoring web impressions for each of a plurality of websites by generating the web impressions at respective web servers corresponding to the respective web sites, and processing the first subset of web impressions of the respective websites using an audience model of visits per household (VHH) for the respective websites to derive respective partial estimates of the unique audience for the respective websites, wherein the number of visits per household is different for at least two websites.

5. An audience mapping system for mapping web impressions to an estimate of a unique audience, the system having electronic components configured to:
monitor web impressions made with respect to a website to identify user devices used to make the web impressions in respect of content on the website by generating the web impressions at the web server hosting the content, wherein each web impression is generated by reporting code embedded within one or more items of content hosted on the website in response to an activity related to the respective item of content;
compare identified user devices to a database in which a plurality of user devices are linked to households to produce a first subset of web impressions to which households are matched, and a second subset of web impressions having no matched household;
process the first subset of web impressions using an audience model of visits per household (VHH) for the website to obtain a partial estimate of the unique audience; and
adjust the partial estimate of the unique audience to take into account the second subset of impressions in order to derive a final estimate of the unique audience for the website.

6. An audience mapping system as claimed in claim 5, configured to output and/or store the final estimate of the unique audience.

7. An audience mapping system as claimed in claim 5, wherein the system is configured to adjust the first estimate by matching the second subset of impressions to households associated with the first subset of impressions to derive values of visits per household for the second subset of impressions.

8. An audience mapping system as claimed in claim 5, configured to monitor web impressions for each of a plurality of websites by generating the web impressions at respective web servers corresponding to the respective web sites, and processing the first subset of web impressions of the respective websites using an audience model of visits per household (VHH) for the respective websites to derive respective partial estimates of the unique audience for the respective websites, wherein the number of visits per household is different for at least two websites.

9. (canceled)

10. A tangible computer readable medium comprising the program code which when executed implements the method of claim 1.
